(19) United States
(12) Patent Application Publication
(10) Pub. No.: US 2007/0095609 A1
(43) Pub. Date: May 3, 2007

(54) Quick release ladder bracket

(75) Inventor: Derek Grundler, Hollywood, FL (US)

Correspondence Address: LERNER GREENBERG STEMER LLP, P O BOX 2480, HOLLYWOOD, FL, 33022-2480, US

(73) Assignee: A1A Dock Products, Inc.

(21) Appl. No.: 11/266,631

(22) Filed: Nov. 2, 2005

(51) Int. Cl. E06C 9/00

(52) U.S. Cl. 182/93

(57) ABSTRACT

A quick release bracket for a ladder having a tie-down member includes a frame receiving therein the tie-down member in a form fit and being formed with pinholes. The frame is to be removably fixed at a fixing location. The quick release bracket also includes removable pins shaped to fit into the pinholes. The pins fix the ladder to the frame when the pins are inserted into the pinholes.

### BACKGROUND OF THE INVENTION

### Field of the Invention

The invention lies in the field of ladders, especially marine ladders used on swim floats, docks, and seawalls, for example. The invention relates to a quick release bracket for mounting a ladder, for example, to a dock, or releasing the ladder from the dock easily and quickly without a tool.

In the prior art, the ladders are generally mounted to a dock with a tie-down member that is fixed to the dock surface by nuts and bolts. Whenever a ladder needs to be removed, for example, for storage during the winter or to prevent against theft, it is necessary to remove the nuts and bolts and install them back again. Whenever a ladder needs to be relocated, the screws need to be undone and secured at the new location.

Therefore, there is a need for a device that can be used to quickly and easily release and relocate the ladder without needing a tool.

### SUMMARY OF THE INVENTION

It is accordingly an object of the invention to provide an improved bracket that can be used to easily secure and remove a ladder to and from the position at which it is to be used.

With the foregoing and other objects in view, there is provided, in accordance with the invention, in a ladder system having a ladder with a tie-down member, the ladder to be secured at a fixing location, a quick release bracket comprising:

a frame receiving therein the tie-down member in a form fit and being formed with pinholes, the frame to be removably fixed at the fixing location; and

removable pins shaped to fit into the pinholes, the pins fixing the ladder to the frame when the pins are inserted into the pinholes.

In accordance with another feature of the invention, the frame is approximately U-shaped to define an interior shape; and the tie-down member has an exterior shape substantially corresponding to the interior shape of the frame.

In accordance with a further feature of the invention, there is provided at least one securing device for fastening the pins to the frame.

In accordance with an added feature of the invention, the securing device is a spring-loaded ball bearing for removably fastening the pins to the frame.

In accordance with an additional feature of the invention, the securing device is a cable connecting a respective one of the pins to the frame.

In accordance with yet another feature of the invention, there is provided a fastening assembly mounting the frame to the fixing location.

In accordance with yet a further feature of the invention, the fastening assembly is at least one nut and bolt assembly.

In accordance with yet an added feature of the invention, each of the pins has an expanded portion at one end and a projecting part at another end; the expanded portion has a diameter larger than a diameter of at least one of the pinholes; and the projecting part removably locks the pin in position in one of the pinholes.

In accordance with yet an additional feature of the invention, the frame has a safety portion defining an interior chamber for accommodating therein at least a portion of at least one of said pins.

In accordance with again another feature of the invention, the frame has two sides, one of the sides being formed in an approximate upside-down U-shape and another of the sides being formed in an approximate upside-down L-shape.

In accordance with again a further feature of the invention, the upside-down U-shape has an inner leg with pinholes and an outer leg without pinholes.

With the foregoing and other objects in view, there is also provided, in accordance with the invention, a quick release bracket for a ladder to be removably fixed at a fixing location and having a tie-down member, comprising:

an approximately U-shaped frame for receiving the tie-down member, the frame being formed with pinholes, the frame to be removably fixed at the fixing location; and

removably pins to be inserted into the pinholes and fix the ladder to the frame when the pins are inserted into the pinholes.

With the foregoing and other objects in view, there is also provided, in accordance with the invention, a ladder assembly, comprising:

a ladder having a ladder body and a tie-down member; and

a quick release bracket having:

a U-shaped frame receiving the tie-down member of the ladder therein, the frame being formed with pinholes; and
pins shaped to be removably inserted into the pinholes and removably secure the ladder to the bracket.

With the foregoing and other objects in view, there is also provided, in accordance with the invention, a removable ladder kit, comprising:

a ladder to be secured at a fixing location and having a tie-down member; and

a quick release bracket having:

a frame to be removably fixed at the fixing location, the frame:
   receiving therein the tie-down member in a form fit; and
   being formed with pinholes; and
removable pins shaped to fit into the pinholes, the pins fixing the ladder to the frame when the pins are inserted into the pinholes.

With the foregoing and other objects in view, there is also provided, in accordance with the invention, a quick release bracket for a ladder having a tie-down member with an exterior shape, comprising:

at least one removable securing device; and

a frame having:

a frame body defining an interior shape substantially corresponding to the exterior shape of the tie-down member for receiving the tie-down member therein;
a safety portion defining an interior chamber for accommodating therein at least a portion of the at least one removable securing device; and
a connecting portion shaped to removably receive the at least one removable securing device for removably securing the tie-down member to the frame.

Other features that are considered as characteristic for the invention are set forth in the appended claims.

Although the invention is illustrated and described herein as embodied in a quick release ladder bracket, it is, nevertheless, not intended to be limited to the details shown because various modifications and structural changes may be made therein without departing from the spirit of the invention and within the scope and range of equivalents of the claims.

Additional advantages of the invention will be set forth in part in the description which follows, and in part will be clear from the description, or may be learned by practice of the invention. The advantages of the invention will be realized and attained by the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 is a perspective view of a ladder mounted to a dock by a quick release bracket according to the invention;

FIG. 2 is an exploded perspective view of the ladder and the quick release bracket of FIG. 1 before they are assembled together;

FIG. 3 is a fragmentary, enlarged perspective view of the quick release bracket of FIG. 1 and the corresponding attachment portion of the ladder;

FIG. 4 is a cross-sectional view of the bracket and ladder of FIG. 1 along the section line IV-IV in FIG. 1;

FIG. 5 is an enlarged, partially hidden, fragmentary, elevational side view of the quick release bracket of FIG. 2 with the corresponding connecting portion of the ladder viewed from the interior of the ladder; and

FIG. 6 is an enlarged, partially cross-sectional, partially hidden, and plan view of the quick release bracket of FIG. 1 with the corresponding connecting portion of the ladder.

### DETAILED DESCRIPTION OF THE PREFERRED EMBODIMENTS

The invention may be understood more readily by reference to the following detailed description of preferred embodiments of the invention.

Before the invention is disclosed and described, it is to be understood that the terminology used herein is for the purpose of describing particular embodiments only and is not intended to be limiting. It must be noted that, as used in the specification and the appended claims, the singular forms “a,” “an” and “the” include plural referents unless the context clearly dictates otherwise.

The invention will now be described in detail with reference to the accompanying drawings.

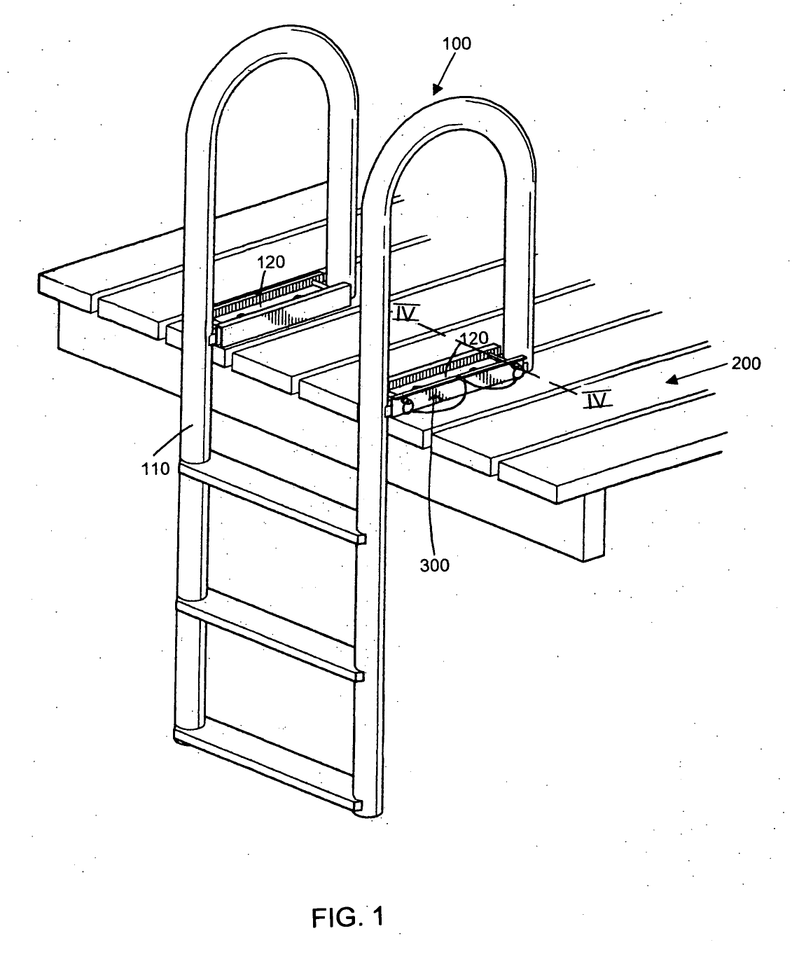

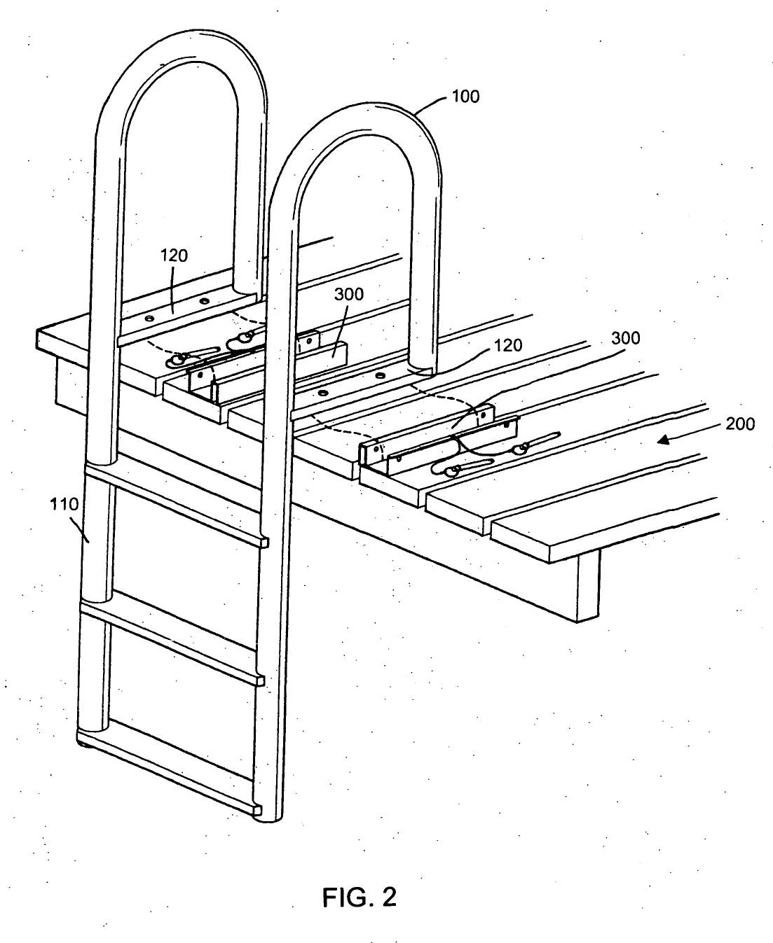

Referring now to the figures of the drawings in detail and first, particularly to FIGS. 1 and 2 thereof, there is shown a ladder 100, which is mounted to a dock 200 by a quick release bracket 300 according to the invention. The ladder 100 has a ladder body 110 and a tie-down member 120 to be mounted to the dock 200.

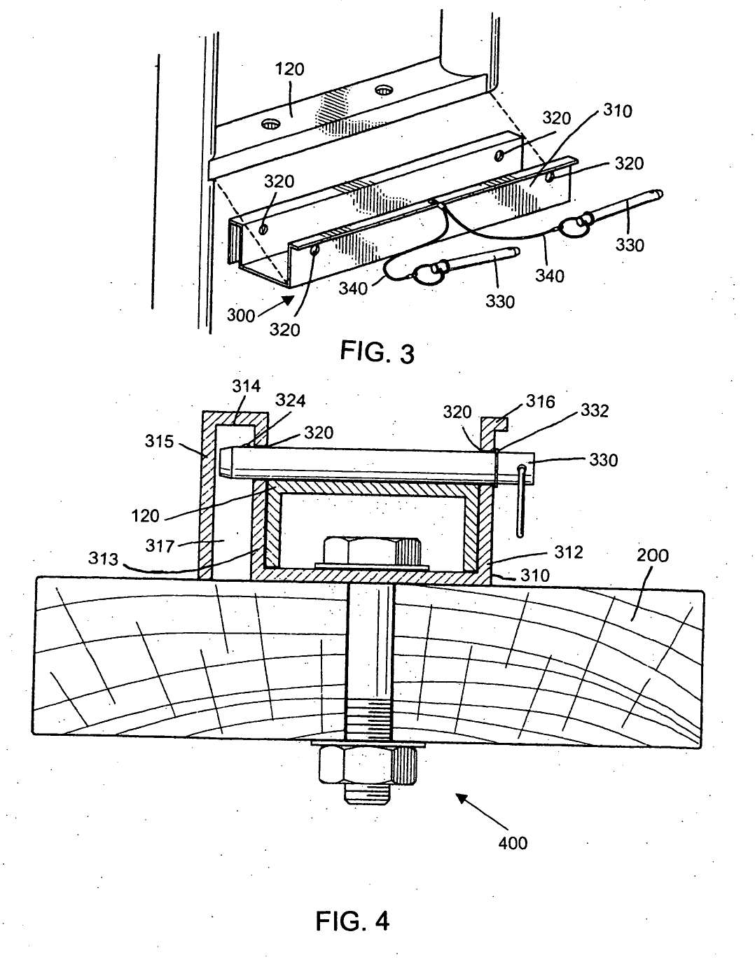

As can be seen more clearly in FIG. 3, the quick release bracket 300 has a U-shaped frame 310 for receiving the tie-down member 120 of the ladder 100. The U-shaped frame 310 is formed with four pinholes 320, two on each side thereof. The pinholes 320 on one side of the U-shaped frame 310 align with the pinholes 320 formed on the other side of the U-shaped frame 310. Two pins 330 are attached to the U-shaped frame 310 by cables 340 and are to be inserted into the pinholes 320. Of course, the U-shaped frame 310 may be formed with more pinholes and more pins can be used to increase stability. Also, it is not necessary to secure the pins 330 to the frame 310.

As can be seen in FIG. 4, the U-shaped frame 310 of the quick release bracket 300 is fixed to the dock 200 by nut and bolt assemblies 400 (only one nut and bolt assembly 400 is shown in FIG. 4). The U-shaped frame 310 as shown in FIG. 4 has a cross-section in which one side 314 of the U-shaped frame 310 has an upside-down U-shape and the other side 312 of the U-shaped frame 310 has an upside-down L-shape. The inner leg 313 of the upside-down U-shaped side 314 is formed with pinholes 320. In contrast, the outer leg 315 of the upside-down U-shaped side 314 does not have pinholes 320. Therefore, the upside-down U-shaped side 314 forms a chamber 317, which partially accommodates the pins 330. Not only does the chamber 317 provide protection for the pins 330, more importantly, the outer leg 315 forming the chamber 317 guards the distal ends of the pins projecting from the inner leg 313 and, thereby, prevents a person from catching their foot on the pin 330. The left side 314 as viewed in FIG. 4 need not be in the squared-off U-shape. To further prevent injury to a user, the cross-section can have a curve at the top. Thus, the two corners shown in FIG. 4 are eliminated. Another alternative is to form the left side 314 with a hemispherical cross-section.

The outer side 315 of the upside-down U-shape side 314 may limit the distance that the pins 330 can extend. The upper side 316 of the upside-down L-shape side 312 may also, to certain extent, protect the pins 330. Preferably, the pins 330 have an expanded portion 332 at one end thereof, which has a diameter slightly larger than the diameter of the pinhole 320 to prevent over-insertion of the pins 330. The pins 330 may also have a projecting part 324 at the other end thereof, which can lock the pins 330 in position, but can be inserted into and pulled out of the pinhole 320 with slight force. The preferred embodiment of the projecting part 324 is a spring biased ball bearing that can be pressed into the shaft of the pin 330 when the projecting part 324 is passing through the pinholes 320 (having a diameter substantially equal to the outer diameter of the pin 330).

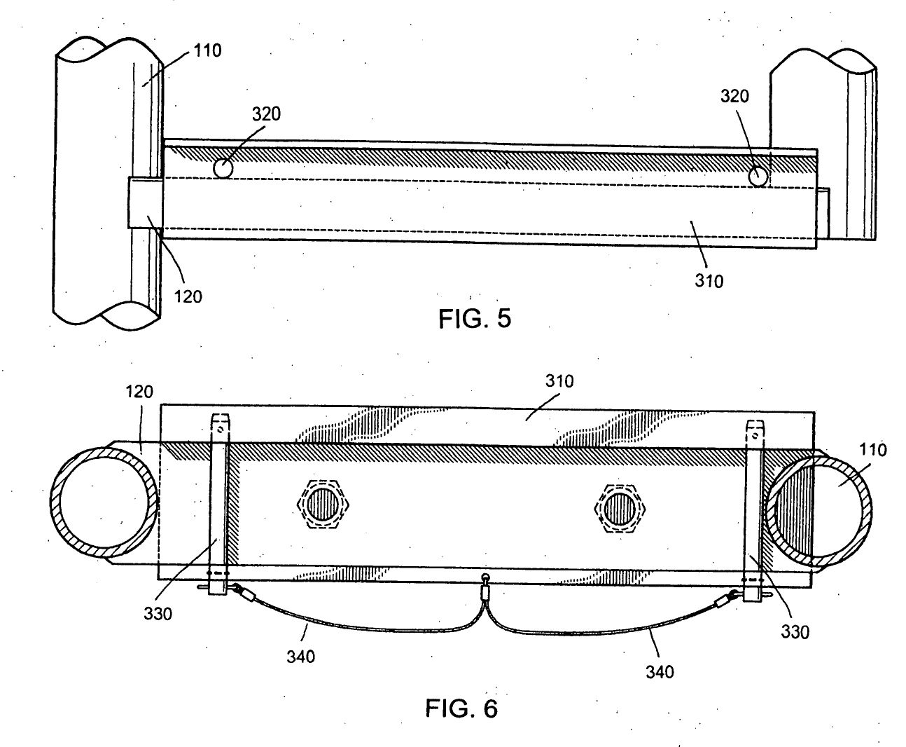

FIGS. 5 and 6 are side and top views of the quick release bracket 300 with the corresponding portion of the tie-down member 120 of the ladder 100 in assembled condition.

The quick release bracket 300 according to the invention has the advantage that the ladder 100 can be secured to and released from the dock 200 quickly without using any tools. The ladder 100 can be quickly mounted to the dock 200 by lowering the tie-down member 120 into the U-shaped frame 310 of the quick release bracket 300 (which is already secured to the dock 200) and inserting the pins 330 into the pinholes 32u formed in the U-shaped frame 310. The ladder 100 can also be quickly removed from the dock 200 by removing the pins 330 from the pinholes 320 and lifting the ladder 100 from the U-shaped frame 310 of the quick release bracket 300. This facilitates the storage and repair of the ladder. In other words, the bracket 300 can be fixed to the dock and left there permanently or semi-permanently, but the ladder can be removed at any time and stored somewhere else after use until the next time it is needed. In this way, the life span of the ladder 100 can be extended.

I claim:

1. In a ladder system having a ladder with a tie-down member, the ladder to be secured at a fixing location, a quick release bracket comprising:
a frame receiving therein the tie-down member in a form fit and being formed with pinholes, said frame to be removably fixed at the fixing location; and
removable pins shaped to fit into said pinholes, said pins fixing the ladder to said frame when said pins are inserted into said pinholes.

2. The quick release bracket according to claim 1, wherein:
said frame is approximately U-shaped to define an interior shape;
the tie-down member has an exterior shape substantially corresponding to said interior shape of said frame.

3. The quick release bracket according to claim 1, further comprising at least one securing device for fastening said pins to said frame.

4. The quick release bracket according to claim 3, wherein said securing device is a spring-loaded ball bearing for removably fastening said pins to said frame.

5. The quick release bracket according to claim 3, wherein said securing device is a cable connecting a respective one of said pins to said frame.

6. The quick release bracket according to claim 1, further comprising a fastening assembly mounting said frame to the fixing location.

7. The quick release bracket according to claim 6, wherein said fastening assembly is at least one nut and bolt assembly.

8. The quick release bracket according to claim 1, wherein:
each of said pins has an expanded portion at one end and a projecting part at another end;
said expanded portion has a diameter larger than a diameter of at least one of said pinholes; and
said projecting part removably locks said pin in position in one of said pinholes.

9. The quick release bracket according to claim 1, wherein said frame has a safety portion defining an interior chamber for accommodating therein at least a portion of at least one of said pins.

10. The quick release bracket according to claim 1, wherein said frame has two sides, one of said sides being formed in an approximate upside-down U-shape and another of said sides being formed in an approximate upside-down L-shape.

11. The quick release bracket according to claim 10, wherein said upside-down U-shape has an inner leg with pinholes and an outer leg without pinholes.

12. A quick release bracket for a ladder to be removably fixed at a fixing location and having a tie-down member, comprising:
an approximately U-shaped frame for receiving the tie-down member, said frame being formed with pinholes, said frame to be removably fixed at the fixing location; and
removably pins to be inserted into said pinholes and fix the ladder to said frame when said pins are inserted into said pinholes.

13. The quick release bracket according to claim 12, wherein:
said frame defines an interior shape;
the tie-down member has an exterior shape substantially corresponding to said interior shape of said frame.

14. The quick release bracket according to claim 12, further comprising a securing device for fastening said pins to said frame.

15. The quick release bracket according to claim 14, wherein said securing device is a spring-loaded ball bearing for removably fastening said pins to said frame.

16. The quick release bracket according to claim 14, wherein said securing device is a cable connecting a respective one of said pins to said frame.

17. The quick release bracket according to claim 12, further comprising a fastening assembly mounting said frame to the fixing location.

18. The quick release bracket according to claim 17, wherein said fastening assembly is at least one nut and bolt assembly.

19. The quick release bracket according to claim 12, wherein:
each of said pins has an expanded portion at one end and a projecting part at another end;
said expanded portion has a diameter larger than a diameter of at least one of said pinholes; and
said projecting part removably locks said pin in position in one of said pinholes.

20. The quick release bracket according to claim 12, wherein said frame has two sides, one of said sides being formed in an approximate upside-down U-shape and another of said sides being formed in an approximate upside-down L-shape.

21. The quick release bracket according to claim 20, wherein said upside-down U-shape has an inner leg with pinholes and an outer leg without pinholes.

22. The quick release bracket according to claim 12, wherein said frame has a safety portion defining an interior chamber for accommodating therein at least a portion of at least one of said pins.

23. A ladder assembly, comprising:
a ladder having a ladder body and a tie-down member; and
a quick release bracket having:
a U-shaped frame receiving said tie-down member of said ladder therein, said frame being formed with pinholes; and
pins shaped to be removably inserted into said pinholes and removably secure said ladder to said bracket.

24. The quick release bracket according to claim 23, wherein said frame has a safety portion defining an interior chamber for accommodating therein at least a portion of at least one of said pins.

25. A removable ladder kit, comprising:
a ladder to be secured at a fixing location and having a tie-down member; and
a quick release bracket having:
a frame to be removably fixed at said fixing location, said frame:
receiving therein said tie-down member in a form fit; and
being formed with pinholes; and
removable pins shaped to fit into said pinholes, said pins fixing said ladder to said frame when said pins are inserted into said pinholes.

26. The quick release bracket according to claim 25, wherein said frame has a safety portion defining an interior chamber for accommodating therein at least a portion of at least one of said pins.

27. A quick release bracket for a ladder having a tie-down member with an exterior shape, comprising:
at least one removable securing device; and
a frame having:
a frame body defining an interior shape substantially corresponding to the exterior shape of the tie-down member for receiving the tie-down member therein;
a safety portion defining an interior chamber for accommodating therein at least a portion of said at least one removable securing device; and
a connecting portion shaped to removably receive said at least one removable securing device for removably securing the tie-down member to said frame.

28. The quick release bracket according to claim 27, wherein said at least one removably securing device is at least one pin.
